(19) United States
(12) Patent Application Publication
(10) Pub. No.: US 2013/0326428 A1
(43) Pub. Date: Dec. 5, 2013

(54) TEXT INPUT METHOD AND APPARATUS

(71) Applicant: HUAWEI TECHNOLOGIES CO., LTD., Shenzhen (CN)

(72) Inventor: Zhilin Liu, Shenzhen (CN)

(73) Assignee: Huawei Technologies Co., Ltd., Shenzhen (CN)

(21) Appl. No.: 13/886,937

(22) Filed: May 3, 2013

Related U.S. Application Data
(63) Continuation of application No. PCT/CN2012/084304, filed on Nov. 8, 2012.

(30) Foreign Application Priority Data
May 30, 2012 (CN) 201210172692.9

(51) Int. Cl. G06F 3/0481

(52) U.S. Cl. CPC G06F 3/04812
USPC 715/856

(57) ABSTRACT

Embodiments of the present invention provide a text input method and apparatus. The method includes: presenting a text input interface on a display apparatus; detecting a first input of an input apparatus, where the first input is used to trigger a query of a text database; presenting, according to the first input, a text set image corresponding to the text database on the text input interface and displaying a cursor in a default position of the text set image, where the text set image includes texts arranged along a circle and the cursor is used to indicate a current selected text; detecting a second input, where the second input is used to select a text in the text set image; and presenting, according to the second input, an input set that matches the text selected in the text set image on the text input interface for inputting.

### CROSS-REFERENCE TO RELATED APPLICATIONS

This application is a continuation of International Application No. PCT/CN2012/084304, filed on Nov. 8, 2012, which claims priority to Chinese Patent Application No. 201210172692.9, filed on May 30, 2012, both of which are hereby incorporated by reference in their entireties.

### TECHNICAL FIELD

The present invention relates to the field of terminal technologies, and in particular, to a text input method and apparatus.

### BACKGROUND

With the development of digital technologies, more and more functions and applications run on terminal equipments (Terminal Equipment), where the text input function is widely used in a vast variety of terminal equipments and applications as an important auxiliary function. However, to improve performance and simplify keys of a terminal equipment, usually only the arrow keys and a few other keys such as the enter key and the power key are provided on the input apparatus of the terminal equipment. Therefore, the input of texts on the terminal equipment is implemented through mainly the arrow keys.

Currently, a frequently used text input method based on arrow keys is to select characters, letters, or numbers by moving the cursor. Specifically, the method includes: presenting a soft keyboard that includes multiple characters, letters, and/or numbers on the display screen and providing a cursor in a default position to identify the currently selected character, letter, or number in the soft keyboard; moving the cursor according to the trigger of the up, down, left, and right arrow keys; when receiving the trigger of the enter key, inputting the character, letter, or number in the cursor position to a text.

During the implementation of the above arrow key based text input, at least the following problem is found: Because characters are selected through a cursor moved by arrow keys, when the cursor is moved, repeated switching between the arrow keys is required and the moving of the cursor is repeated. As a result, the text input operation is complicated, the input efficiency is low, and user experience is weakened.

### SUMMARY

Embodiments of the present invention provide a text input method and apparatus, which can improve the input efficiency.

In one aspect, a text input method is provided, including: presenting a text input interface on a display apparatus; detecting a first input of an input apparatus, where the first input is used to trigger a query of a text database; presenting, according to the first input, a text set image corresponding to the text database on the text input interface and displaying a cursor in a default position of the text set image, where the text set image includes texts arranged along a circle and the cursor is used to indicate a current selected text; detecting a second input of the input apparatus, where the second input is used to select a text in the text set image; and presenting, according to the second input of the input apparatus, an input set that matches the text selected in the text set image on the text input interface for inputting of the input apparatus.

In another aspect, a text input device is provided, including: a presenting unit, an input apparatus, and a detecting unit, where: the presenting unit is configured to present a text input interface on a display apparatus; the detecting unit is configured to detect a first input of the input apparatus, where the first input is used to trigger a query of a text database; the presenting unit is further configured to present, according to the first input detected by the detecting unit, a text set image corresponding to the text database on the text input interface and display a cursor in a default position of the text set image, where the text set image includes texts arranged along a circle and the cursor is used to indicate a current selected text; the detecting unit is further configured to detect a second input of the input apparatus, where the second input is used to select a text in the text set image; and the presenting unit is further configured to present, according to the second input of the input apparatus, an input set that matches the text selected in the text set image on the text input interface for inputting of the input apparatus.

In the foregoing technical solutions, through an input of the input apparatus of a terminal equipment, a text set associated with the input position is presented on the display apparatus. By arranging and presenting the text set along a circle, it is only necessary to move the cursor in one direction to select a text without the need of repeated switching between multiple arrow keys or repeated moving of the cursor in a two-dimensional soft keyboard. This simplifies the text input operation, improves the input efficiency, and enhances user experience.

### BRIEF DESCRIPTION OF THE DRAWINGS

To describe the technical solutions in the embodiments of the present invention more clearly, the following briefly introduces the accompanying drawings required for describing the embodiments of the present invention. Apparently, the accompanying drawings in the following description show merely some embodiments of the present invention, and a person of ordinary skill in the art may still derive other drawings from the accompanying drawings without creative efforts.

FIG. 1 is a schematic diagram of an input apparatus of a terminal equipment in a related art;

FIG. 2 is a schematic block diagram of a terminal equipment in a related art;

FIG. 3 is a schematic flowchart of a text input method according to an embodiment of the present invention;

FIG. 4 is a schematic flowchart of a text input method according to another embodiment of the present invention;

FIG. 5A-FIG. 5I are schematic diagrams of another embodiment of the present invention; and

FIG. 6A and FIG. 6B are schematic block diagrams of a text input device according to an embodiment of the present invention.

### DETAILED DESCRIPTION

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments in the present invention without creative efforts shall fall within the protection scope of the present invention.

The term “and/or” in this document is only an association relationship for describing the associated objects, and represents that three relationships may exist, for example, A and/or B may represent the following three cases: A exists separately, and both A and B exist, and B exists separately. In addition, the character “/” in this document usually represents that the former and later associated objects are in an “or” relationship.

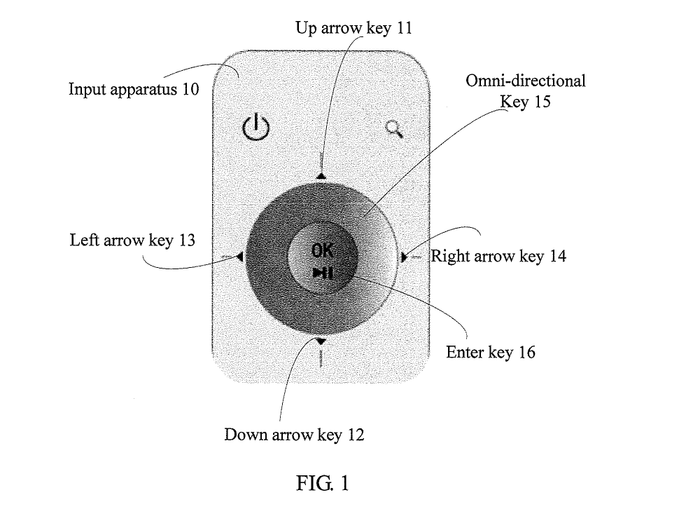

FIG. 1 is a schematic diagram of an input apparatus 10 of a terminal equipment in a related art. The input apparatus 10 includes: an up arrow key 11, a down arrow key 12, a left arrow key 13, a right arrow key 14, and/or an enter key 16, or optionally, includes an omni-directional key 15 which is a special form of arrow keys. The omni-directional key 15 can move clockwise or counter-clockwise along a circle and allow an input in any position in the circle. In a shuttle remote (Shuttle Remote), the usual implementation mode is that the omni-directional key 15 integrates the up arrow key 11, the down arrow key 12, the left arrow key 13, and the right arrow key 14. For example, an input of the omni-directional key 15 in a position corresponding to three o'clock in a clock is equivalent to an input of the right arrow key 14.

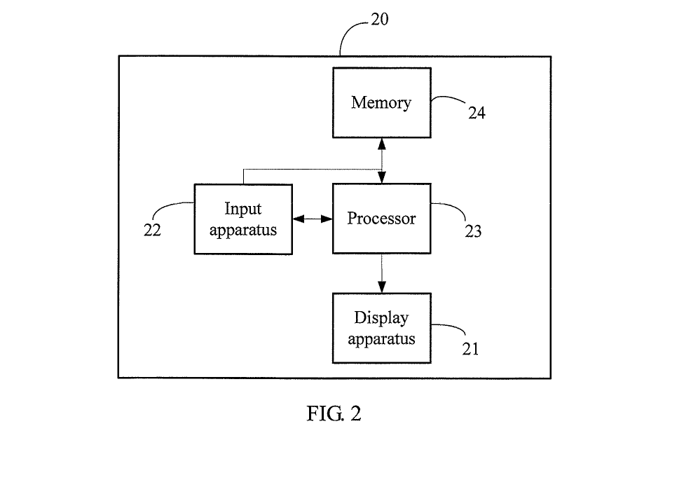

FIG. 2 is a schematic block diagram of a terminal equipment 20 in a related art. The terminal equipment 20 includes a display apparatus 21, an input apparatus 22, a processor 23, and a memory 24. The input apparatus 22 is the same as or similar to the input apparatus 10 shown in FIG. 1.

The display apparatus 21 may be a suitable apparatus configured to present graphic user interfaces, such as a cathode ray tube (CRT, Cathode Ray Tube) display or a liquid crystal display (LCD, Liquid Crystal Display).

The input apparatus 22 may include any suitable apparatus like a keyboard, a mouse, a track recognizer, and a speech recognizing interface, configured to receive an user input and send the input to the processor.

The memory 24 may include a RAM and a ROM, or any fixed storage medium, or a removable storage medium, configured to store a program that can execute an embodiment of the present invention or to store an application database of the embodiment of the present invention.

The processor 23 is configured to execute the program of the embodiment of the present invention stored by the memory 24 and communicate with other apparatuses bi-directionally through buses.

The memory 24 and the processor 23 may be integrated into a physical module where the embodiment of the present invention is applied. The physical module stores and runs the program that implements the embodiment of the present invention.

The embodiment of the present invention may be applied to the above terminal equipment 20, and the input apparatus 22 includes but not limited to a television remote input apparatus, a handset, computer and the like. Any equipment that includes arrow keys and an enter key or that can use other keys such as volume keys, a central control key, and an “OK” key to replace the arrow keys and the enter key can adopt the method of the embodiment of the present invention.

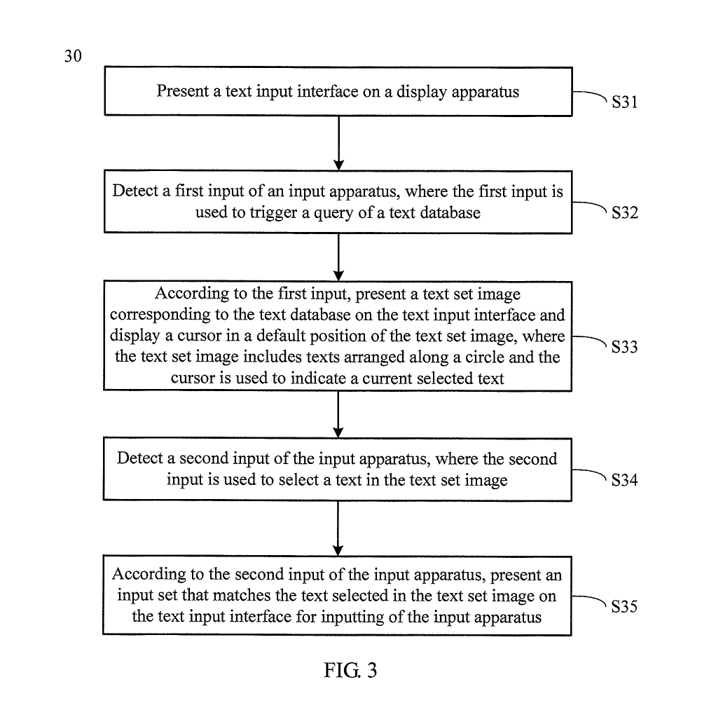

FIG. 3 is a schematic flowchart of a text input method 30 according to an embodiment of the present invention.

S31. Present a text input interface on a display apparatus.

S32. Detect a first input of an input apparatus, where the first input is used to trigger a query of a text database.

S33. According to the first input, present a text set image corresponding to the text database on the text input interface and display a cursor in a default position of the text set image, where the text set image includes texts arranged along a circle and the cursor is used to indicate a current selected text.

S34. Detect a second input of the input apparatus, where the second input is used to select a text in the text set image.

S35. According to the second input of the input apparatus, present an input set that matches the text selected in the text set image on the text input interface for inputting of the input apparatus.

In the embodiment of the present invention, through the input of the input apparatus of the terminal equipment, a text set associated with the input position is presented on the display apparatus. By arranging and presenting the text set along a circle, it is only necessary to move the cursor in one direction to select a text without the need of repeated switching between multiple arrow keys or repeated moving of the cursor in a two-dimensional soft keyboard. This simplifies the text input operation, improves the input efficiency, and enhances user experience.

Optionally, an input of any arrow key of the input apparatus is detected, the position of the cursor in the text set image is determined according to the physical position of the input, and a portion of the text set is highlighted and presented in a corresponding position of the text set image on the text input interface.

Optionally, when arrow keys of the input apparatus include an up arrow key, an input of the up arrow key is detected, that the cursor is moved to right above the text set image is determined according to the physical position of the input, and the portion of the text set right above the text set image is highlighted and presented; when the arrow keys of the input apparatus include a down arrow key, an input of the down arrow key is detected, that the cursor is moved to right below the text set image is determined according to the physical position of the input, and the portion of the text set right below the text set image is highlighted and presented; when the arrow keys of the input apparatus include a left arrow key, an input of the left arrow key is detected, that the cursor is moved to the left of the text set image is determined according to the physical position of the input, and the portion of the text set on the left of the text set image is highlighted and presented; when the arrow keys of the input apparatus include a right arrow key, an input of the right arrow key is detected, that the cursor is moved to the right of the text set image is determined according to the physical position of the input, and the portion of the text set on the right of the text set image is highlighted and presented.

Optionally, when another input of the same arrow key is detected within a time threshold, that the cursor moves along the circle from the current position to a next text sequentially arranged in the text set image is presented.

Optionally, when the arrow keys of the input apparatus include an omni-directional key, a rotating track of the omni-directional key of the input apparatus is detected, the moving direction of the cursor is determined according to the rotating track, that the cursor moves along the circle in the text set image is presented accordingly on the text input interface, and the text in the position where the cursor is located is highlighted and presented.

Optionally, when another rotating track of the omni-directional key is detected within the time threshold, the moving direction of the cursor is determined according to the rotating track. When the moving direction of the cursor is the same as the arranging sequence of texts in the text set image, that the cursor moves along the circle from the current position to a next text sequentially arranged in the text set image is presented; or when the moving direction of the cursor is reverse to the arranging sequence of texts in the text set image, that the cursor moves along the circle from the current position to a previous text sequentially arranged in the text set image is presented.

Optionally, when no input of the same arrow key is detected within the time threshold, or when no input of the same arrow key is detected within the time threshold and another input of the same arrow key is detected after the time threshold expires, or when an input of an enter key in the input apparatus is detected, the text database is queried to obtain an input set that matches the text currently selected by the cursor in the text set image and the input set is presented on the text input interface for inputting of the input apparatus.

Optionally, the input apparatus of the apparatus is a shuttle remote that includes an omni-directional key used to move clockwise or counter-clockwise along a circle and allow an input in any position along the circle.

Optionally, when the text database includes a letter database, a text set image corresponding to the letter database is presented on the text input interface and the cursor is displayed in a default position of the text set image, where the text set image includes letters arranged along a circle and the cursor is used to indicate the current selected letter; or, when the text database includes a number database, a text set image corresponding to the number database is presented on the text input interface and the cursor is displayed in a default position of the text set image, where the text set image includes numbers arranged along a circle and the cursor is used to indicate the current selected number; or when the text database includes a character database, a text set image corresponding to the character database is presented on the text input interface and the cursor is displayed in a default position of the text set image, where the text set image includes characters arranged along a circle and the cursor is used to indicate the current selected character.

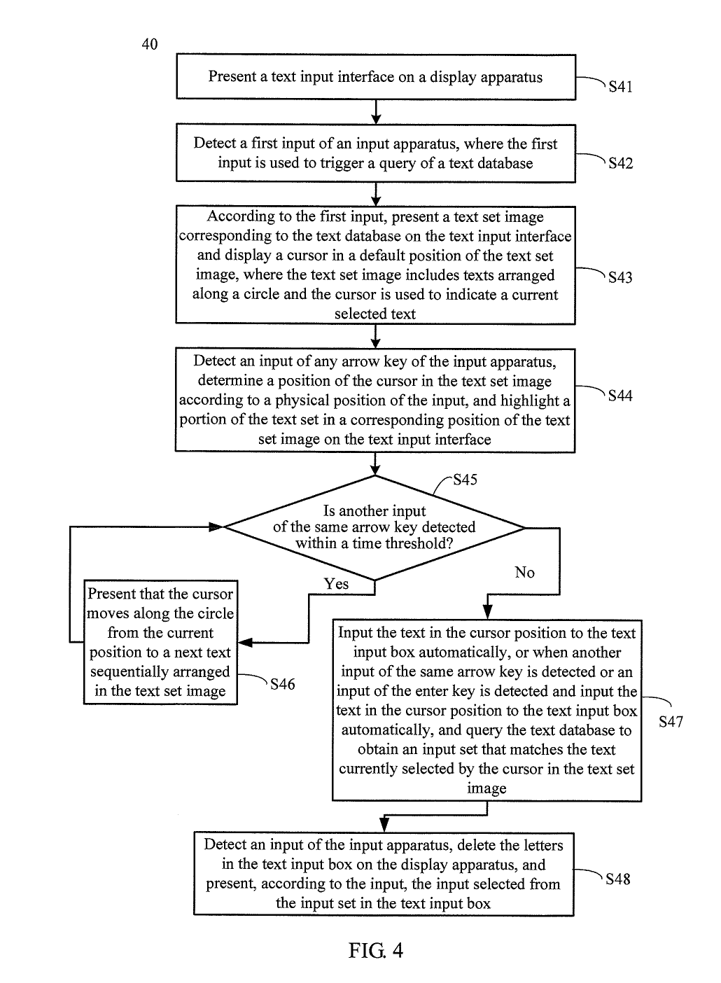

FIG. 4 is a schematic flowchart of a text input method 40 according to an embodiment of the present invention. The method 40 is described by using the input apparatus 10 shown in FIG. 1 as an example.

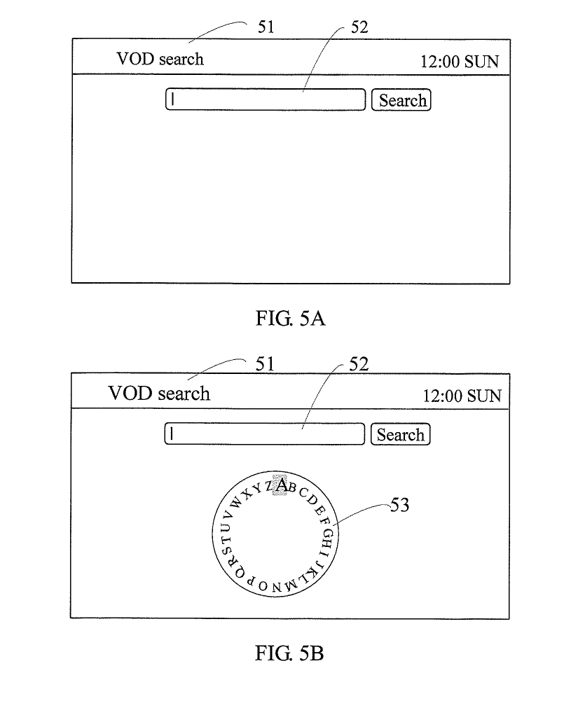

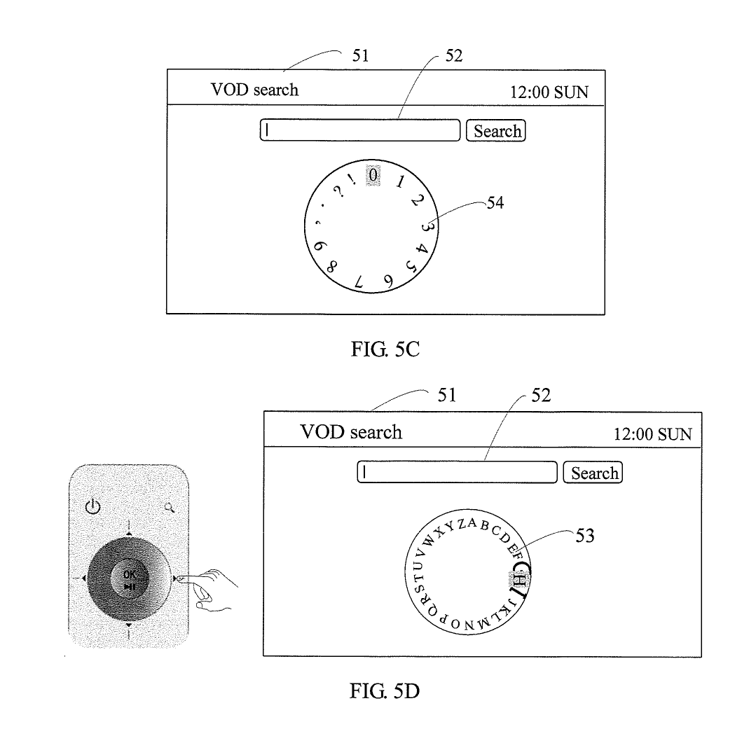

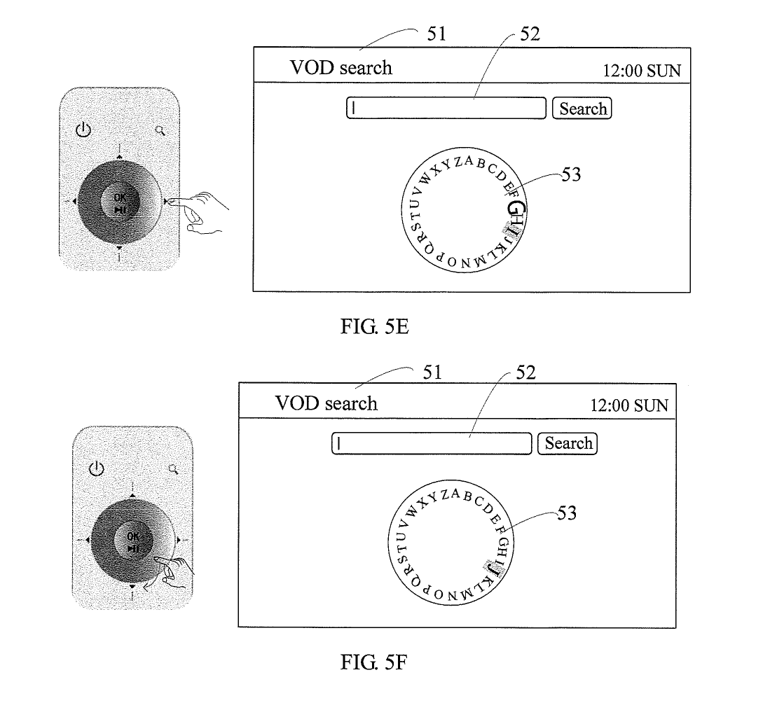

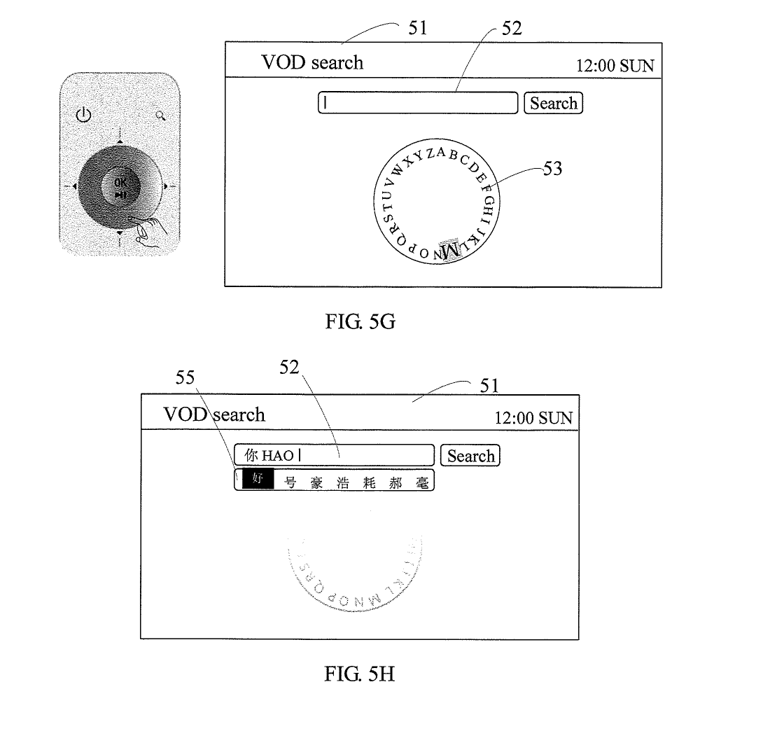

S41. Present a text input interface on a display apparatus, as shown by 51 in FIG. 5A, which includes a text input box 52.

S42. Detect a first input of an input apparatus, where the first input is used to trigger a query of a text database.

The user may press any arrow key of the input apparatus.

S43. According to the first input, present a text set image corresponding to the text database on the text input interface and display a cursor in a default position of the text set image, where the text set image includes texts arranged along a circle and the cursor is used to indicate a current selected text.

The text database may include a letter database, a character database, and/or a number database, and texts made up thereof such as words and phrases. The corresponding text sets are respectively a letter set, a character set, and/or a number set. In this case, the text set image presented on the display apparatus is, for example, 1-26 English letters, as shown by 53 in FIG. 5B. Optionally, combination of letters, characters, and/or numbers may be presented in the text set image, as shown by 54 in FIG. 5C. If there are multiple text set images, the user may switch between the multiple text set images by using predefined keys such as a volume key “+” or “−”, and the text set image is presented on the display apparatus for conveniently inputting a text. Preferably, the presented text set complies with a certain arranging rule. For example, texts are arranged clockwise or counter-clockwise to facilitate subsequent operations. It should be noted that the categorizing method of text sets includes but is not limited to the above method. Other reasonable arranging methods may also be applied to the embodiments of the present invention.

Then, the selection of a corresponding text is triggered through the cursor position moved quickly clockwise or counter-clockwise by arrow keys. Compared with the prior art where texts are mixed and displayed on the screen, this reduces the moving of the cursor.

S44. Detect an input of any arrow key of the input apparatus, determine a position of the cursor in the text set image according to a physical position of the input, and highlight a portion of the text set in a corresponding position of the text set image on the text input interface.

For clear description, the embodiments hereinafter are described by using the input of letters, which is not limited by the embodiments of the present invention. For example, when the user presses the right arrow key of the input apparatus, on the display apparatus, the cursor moves to the position of the text “H” corresponding to the physical position of the right arrow key, in the text set image, and a portion of the text set is highlighted and presented in a corresponding position of the text set image. As shown in FIG. 5D, for example, the cursor is located in the position of “H” and some letters such as “G”, “H”, and “I” in the position are highlighted and presented in a bigger font. The form of the cursor and the highlighting method may be selecting a box, highlighting the current item, or boldfacing, and so on. The embodiment of the present invention includes but is not limited to the above forms. For simple description, such forms are not described herein again.

S45. Determine whether another input of the same arrow key is detected within a time threshold. If “yes”, execute step S46. If “no”, execute step S47.

S46. When another input of the same arrow key is detected within a time threshold, present that the cursor moves along the circle from the current position to a next text sequentially arranged in the text set image.

Within the time threshold, if the user presses the right arrow key of the input apparatus again, the cursor moves in the clockwise direction of letter arrangement from letter “H” to the next letter “I” on the display apparatus, as shown in FIG. 5E.

By arranging and displaying the text set in a circle, the selection of letters only needs cursor moving in one direction and does not need repeated switching between multiple arrow keys or repeated moving of the cursor in a two-dimensional soft keyboard. This simplifies the text input operation, improves the input efficiency, and enhances user experience.

Optionally, if the arrow keys of the input apparatus of a shuttle remote, for example, include an omni-directional key, when the rotating track of the omni-directional key is clockwise shown by the arrow in FIG. 5F, the moving direction of the cursor is determined according to the rotating track of the omni-directional key, that the cursor moves clockwise along the circle in the text set image is presented on the text input interface accordingly, and the text in the position where the cursor is located is highlighted and presented. As shown in FIG. 5F and FIG. 5G, the cursor moves from the letter “J” to the next letter “M”. The case of counter-clockwise moving of the omni-directional key is similar to the above description, and for brevity, details are not described herein again. An omni-directional key has one more moving direction than single arrow keys, thus further reducing the number of keystrokes.

S47. When no input of the same arrow key is detected within a time threshold, input the text in the cursor position to a text input box automatically, and optionally, when no input of the same arrow key is detected within the time threshold and another input of the same arrow key is detected after the time threshold expires, or when no input of the same arrow key is detected within the time threshold and an input of the enter key of the input apparatus is detected after the time threshold expires, input the text in the cursor position to the text input box, and query the text database to obtain an input set that matches the text currently selected by the cursor in the text set image.

As shown in FIG. 5H, when the user presses the same arrow key again, where the arrow key includes an omni-directional key, or presses the enter key, the current selected text indicated by the cursor is selected and the selected text is presented in the text input box 52 and an input set 55 that matches the current selected text is presented. Herein, the input set 55 is a set of Chinese characters. As shown in FIG. 5H, the text database is queried according to the pinyin “hao” entered in the text input box 52 to obtain a set of Chinese characters that match the pinyin “hao” including “ [symbol] , [symbol] , [symbol] , [symbol] ” and the like, and the obtained set of Chinese characters is presented according to a preset display rule. The specific presenting method may depend on the specific condition of the display apparatus and is not limited by the embodiment of the present invention.

S48. Detect an input of the input apparatus, delete the letters in the text input box on the display apparatus, and present, according to the input, the input selected from the input set in the text input box.

The user may move the arrow keys and press the enter key to input the selected one from the obtained set of Chinese characters to the text input box and delete the pinyin used for matching in the text input box, and optionally, hide the display bar of the input set. Taking FIG. 5I as an example, the Chinese character “ [symbol] ” may be input to the text input box by inputs of the arrow keys and the enter key. The specific method for selecting or inputting a Chinese character includes but is not limited to this step. It may be decided according to the specific condition of the input apparatus. For example, the cursor is moved by using the volume keys. The embodiment of the present invention does not describe such methods herein again.

In the embodiment of the present invention, through the input of the input apparatus of the terminal equipment, a text set associated with the input position is presented on the display apparatus. By arranging and presenting the text set along a circle, it is only necessary to move the cursor in one direction to select a text without the need of repeated switching between multiple arrow keys or repeated moving of the cursor in a two-dimensional soft keyboard. This simplifies the text input operation, improves the input efficiency, and enhances user experience.

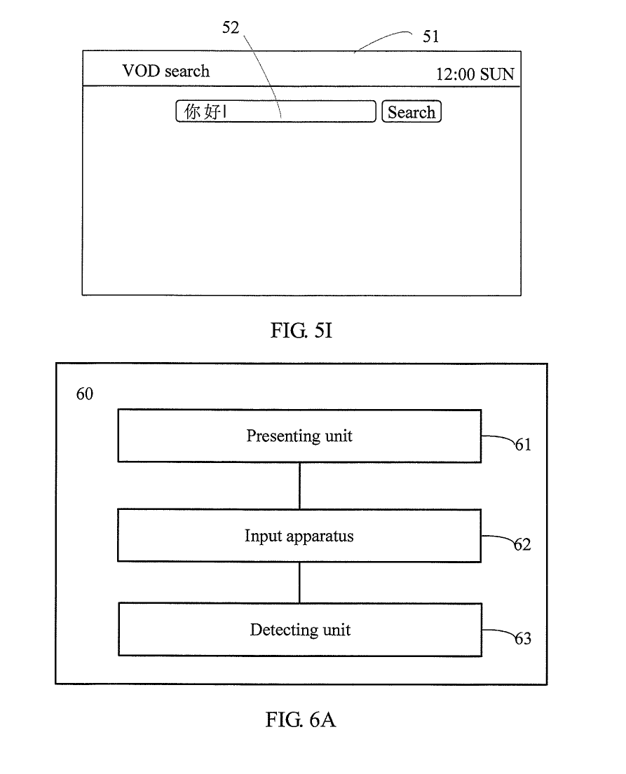

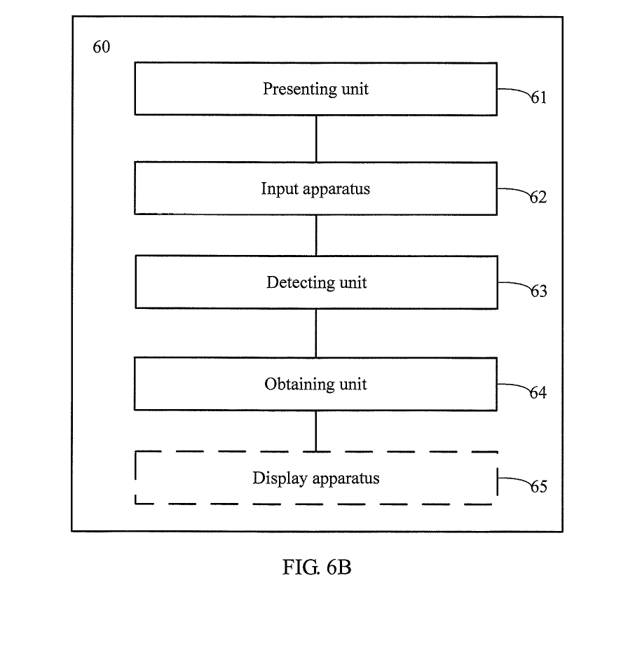

FIG. 6A and FIG. 6B are schematic block diagrams of a text input device 60 according to an embodiment of the present invention. As shown in FIG. 6A, the apparatus 60 includes a presenting unit 61, an input apparatus 62, and a detecting unit 63.

The presenting unit 61 is configured to present a text input interface on a display apparatus 65.

The detecting unit 63 is configured to detect a first input of the input apparatus 62, where the first input is used to trigger a query of a text database.

The presenting unit 61 is further configured to present, according to the first input detected by the detecting unit 63, a text set image corresponding to the text database on the text input interface and display a cursor in a default position of the text set image, where the text set image includes texts arranged along a circle and the cursor is used to indicate the current selected text.

The detecting unit 63 is further configured to detect a second input of the input apparatus 62, where the second input is used to select a text in the text set image.

The presenting unit 61 is further configured to present, according to the second input of the input apparatus 62, an input set that matches the text selected in the text set image on the text input interface for inputting of the input apparatus.

In the embodiment of the present invention, through the input of the input apparatus of the terminal equipment, a text set associated with the input position is presented on the display apparatus. By arranging and presenting the text set along a circle, it is only necessary to move the cursor in one direction to select a text without the need of repeated switching between multiple arrow keys or repeated moving of the cursor in a two-dimensional soft keyboard. This simplifies the text input operation, improves the input efficiency, and enhances user experience.

FIG. 6B is a schematic block diagram of the text input device 60 according to another embodiment of the present invention. Unlike the apparatus 60 in FIG. 6A, the apparatus 60 in FIG. 6B further includes an obtaining module 64.

In addition, optionally, the detecting unit detects an input of any arrow key of the input apparatus, and the presenting unit determines the position of the cursor in the text set image according to the physical position of the input and highlights a portion of the text set in a corresponding position of the text set image on the text input interface.

Optionally, when arrow keys of the input apparatus include an up arrow key, the detecting unit detects an input of the up arrow key, and the presenting unit determines, according to the physical position of the input, that the cursor moves to right above the text set image and highlights the portion of the text set right above the text set image.

Optionally, when the arrow keys of the input apparatus include a down arrow key, the detecting unit detects an input of the down arrow key, and the presenting unit determines, according to the physical position of the input, that the cursor moves to right below the text set image and highlights the portion of the text set right below the text set image.

Optionally, when the arrow keys of the input apparatus include a left arrow key, the detecting unit detects an input of the left arrow key, and the presenting unit determines, according to the physical position of the input, that the cursor moves to the left of the text set image and highlights the portion of the text set on the left of the text set image.

Optionally, when the arrow keys of the input apparatus include a right arrow key, the detecting unit detects an input of the right arrow key, and the presenting unit determines, according to the physical position of the input, that the cursor moves to the right of the text set image and highlights the portion of the text set on the right of the text set image.

Optionally, when the detecting unit detects another input of the same arrow key within a time threshold, the presenting unit presents that the cursor moves along the circle from the current position to a next text sequentially arranged in the text set image.

Optionally, when the arrow keys of the input apparatus include an omni-directional key, the detecting unit detects a rotating track of the omni-directional key of the input apparatus, and the presenting unit determines the moving direction of the cursor according to the rotating track, presents accordingly that the cursor moves along the circle in the text set image on the text input interface, and highlights a text in the position where the cursor is located.

Optionally, when the detecting unit detects another rotating track of the omni-directional key within the time threshold, the presenting unit determines the moving direction of the cursor according to the rotating track. When the moving direction of the cursor is the same as the arranging sequence of texts in the text set image, the presenting unit presents that the cursor moves along the circle from the current position to a next text sequentially arranged in the text set image; or when the moving direction of the cursor is reverse to the arranging sequence of texts in the text set image, the presenting unit presents that the cursor moves along the circle from the current position to a previous text sequentially arranged in the text set image.

Optionally, when the detecting unit detects no input of the same arrow key within the time threshold, or when the detecting unit detects no input of the same arrow key within the time threshold and detects another input of the same arrow key after the time threshold expires, or detects an input of an enter key in the input apparatus, the obtaining unit queries the text database to obtain an input set that matches the text currently selected by the cursor in the text set image and the presenting unit presents the input set obtained by the obtaining unit on the text input interface for inputting of the input apparatus.

Optionally, the input apparatus of the apparatus is a shuttle remote that includes an omni-directional key used to move clockwise or counter-clockwise along a circle and allow an input in any position along the circle.

Optionally, when the text database includes a letter database, the presenting unit presents a text set image corresponding to the letter database on the text input interface and displays a cursor in a default position of the text set image, where the text set image includes letters arranged along a circle and the cursor is used to indicate a current selected letter.

Optionally, when the text database includes a number database, the presenting unit presents a text set image corresponding to the number database on the text input interface and displays a cursor in a default position of the text set image, where the text set image includes numbers arranged along a circle and the cursor is used to indicate a current selected number.

Optionally, when the text database includes a character database, the presenting unit presents a text set image corresponding to the character database on the text input interface and displays a cursor in a default position of the text set image, where the text set image includes characters arranged along a circle and the cursor is used to indicate a current selected character.

The apparatus 60 in the foregoing embodiment implements the method 30 and the method 40, and for brevity, details are not described herein again.

The presenting unit 61, the detecting unit 63, and the obtaining unit 64 in the apparatus 60 may be the same as or similar to the processor 23 in the terminal equipment 20, and the input apparatus 62 may be the same as or similar to the input apparatus 22. The memory 24 in the terminal equipment 20 can store a program that executes the method 30 or 40, and store a text database and data to be processed including the input set obtained by the obtaining unit 64 of the apparatus 60. The apparatus 60 may include a display apparatus 65 which is the same as or similar to the display apparatus 21 of the terminal equipment 20, or the method in the embodiment of the present invention may be implemented through other approaches by connecting an external display apparatus.

When the terminal equipment 20 implements the method 30, in S31, the processor 23 presents a text input interface on the display apparatus 21; in S32, the processor 23 detects a first input of the input apparatus 22, where the first input is used to trigger a query of a text database stored by the memory 24; in S34, the processor 23 presents, according to the first input, a text set image corresponding to the text database on the text input interface of the display apparatus 21 and displays a cursor in a default position of the text set image, where the text set image includes texts arranged along a circle and the cursor is used to indicate a current selected text; in S35, the processor 23 detects a second input of the input apparatus 22, where the second input is used to select a text in the text set image; in S36, the processor 23 presents, according to the second input of the input apparatus, an input set that matches the text selected in the text set image on the text input interface presented by the display apparatus for inputting of the input apparatus 22.

In the embodiment of the present invention, through the input of the input apparatus of the terminal equipment, a text set associated with the input position is presented on the display apparatus. By arranging and presenting the text set along a circle, it is only necessary to move the cursor in one direction to select a text without the need of repeated switching between multiple arrow keys or repeated moving of the cursor in a two-dimensional soft keyboard. This simplifies the text input operation, improves the input efficiency, and enhances user experience.

A person of ordinary skill in the art may be aware that, in combination with the examples described in the embodiments disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present invention, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical or other forms.

The units described as separate parts may or may not be physically separate, and parts displayed as units may or may not be physical units, may be located in one position, or may be distributed on multiple network units. A part or all of the units may be selected according to an actual need to achieve the objectives of the solutions of the embodiments.

In addition, functional units in the embodiments of the present invention may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present invention essentially, or the part contributing to the prior art, or part of the technical solutions may be implemented in the form of a software product. The computer software product is stored in a storage medium, and includes several instructions for instructing a computer equipment (which may be a personal computer, a server, a network equipment, and the like) to perform all or part of the steps of the method described in the embodiment of the present invention. The storage medium includes any medium that can store program codes, such as a USB flash disk, a removable hard disk, a read-only memory (ROM, Read-Only Memory), a random access memory (RAM, Random Access Memory), a magnetic disk, or an optical disk.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the appended claims.

What is claimed is:

1. A text input method, comprising:
presenting a text input interface on a display apparatus;
detecting a first input of an input apparatus, wherein the first input is used to trigger a query of a text database;
presenting, according to the first input, a text set image corresponding to the text database on the text input interface and displaying a cursor in a default position of the text set image, wherein the text set image comprises texts arranged along a circle and the cursor is used to indicate a current selected text;
detecting a second input of the input apparatus, wherein the second input is used to select a text in the text set image; and
presenting, according to the second input of the input apparatus, an input set that matches the text selected in the text set image on the text input interface for inputting of the input apparatus.

2. The method according to claim 1, wherein detecting the second input of the input apparatus, comprises:
detecting an input of any arrow key of the input apparatus, determining a position of the cursor in the text set image according to a physical position of the input, and highlighting a portion of the text set in a corresponding position of the text set image on the text input interface.

3. The method according to claim 2, wherein detecting an input of any arrow key of the input apparatus, determining a position of the cursor in the text set image according to a physical position of the input, and highlighting a portion of the text set in a corresponding position of the text set image on the text input interface comprise:
when arrow keys of the input apparatus comprise an up arrow key, detecting an input of the up arrow key, determining, according to a physical position of the input, that the cursor moves to right above the text set image, and highlighting the portion of the text set right above the text set image;
when the arrow keys of the input apparatus comprise a down arrow key, detecting an input of the down arrow key, determining, according to a physical position of the input, that the cursor moves to right below the text set image, and highlighting the portion of the text set right below the text set image;
when the arrow keys of the input apparatus comprise a left arrow key, detecting an input of the left arrow key, determining, according to a physical position of the input, that the cursor moves to the left of the text set image, and highlighting the portion of the text set on the left of the text set image; or
when the arrow keys of the input apparatus comprise a right arrow key, detecting an input of the right arrow key, determining, according to a physical position of the input, that the cursor moves to the right of the text set image, and highlighting the portion of the text set on the right of the text set image.

4. The method according to claim 2, wherein, after detecting the second input of the input apparatus, the method further comprises:
when another input of the same arrow key is detected within a time threshold, presenting that the cursor moves along the circle from the current position to a next text sequentially arranged in the text set image.

5. The method according to claim 1, wherein detecting the second input of the input apparatus, comprises:
when arrow keys of the input apparatus comprise an omni-directional key, detecting a rotating track of the omni-directional key of the input apparatus, determining a moving direction of the cursor according to the rotating track, presenting accordingly that the cursor moves along the circle in the text set image on the text input interface, and highlighting a text in the position where the cursor is located.

6. The method according to claim 5, wherein, after detecting the second input of the input apparatus, the method further comprises:
when another rotating track of the omni-directional key is detected within a time threshold, determining a moving direction of the cursor according to the rotating track; and
when the moving direction of the cursor is the same as the arranging sequence of texts in the text set image, presenting that the cursor moves along the circle from the current position to a next text sequentially arranged in the text set image; or
when the moving direction of the cursor is reverse to the arranging sequence of texts in the text set image, presenting that the cursor moves along the circle from the current position to a previous text sequentially arranged in the text set image.

7. The method according to claim 2, wherein presenting the input set that matches the text selected in the text set image on the text input interface for inputting of the input apparatus comprises:
when no input of the same arrow key is detected within a time threshold, or when no input of the same arrow key is detected within the time threshold and another input of the same arrow key is detected after the time threshold expires, or when an input of an enter key in the input apparatus is detected, querying the text database to obtain an input set that matches the text currently selected by the cursor in the text set image; and
presenting the input set on the text input interface for inputting of the input apparatus.

8. The method according to claim 7, wherein the input apparatus is a shuttle remote that comprises an omni-directional key used to move clockwise or counter-clockwise along the circle and allow an input in any position along the circle.

9. The method according to claim 1, wherein presenting the text set image corresponding to the text database on the text input interface and displaying the cursor in the default position of the text set image, comprise:
when the text database comprises a letter database, presenting a text set image corresponding to the letter database on the text input interface and displaying a cursor in a default position of the text set image, wherein the text set image comprises letters arranged along a circle and the cursor is used to indicate a current selected letter; or
when the text database comprises a number database, presenting a text set image corresponding to the number database on the text input interface and displaying a cursor in a default position of the text set image, wherein the text set image comprises numbers arranged along a circle and the cursor is used to indicate a current selected number; or
when the text database comprises a character database, presenting a text set image corresponding to the character database on the text input interface and displaying a cursor in a default position of the text set image, wherein the text set image comprises characters arranged along a circle and the cursor is used to indicate a current selected character.

10. A text input device, comprising:
a presenting unit;
an input apparatus;
a detecting unit; and
wherein:
the presenting unit is configured to present a text input interface on a display apparatus;
the detecting unit is configured to detect a first input of the input apparatus, wherein the first input is used to trigger a query of a text database;
the presenting unit is further configured to present, according to the first input detected by the detecting unit, a text set image corresponding to the text database on the text input interface and display a cursor in a default position of the text set image, wherein the text set image comprises texts arranged along a circle and the cursor is used to indicate a current selected text;
the detecting unit is further configured to detect a second input of the input apparatus, wherein the second input is used to select a text in the text set image; and
the presenting unit is further configured to present, according to the second input of the input apparatus, an input set that matches the text selected in the text set image on the text input interface for inputting of the input apparatus.

11. The apparatus according to claim 10, wherein:
the detecting unit detects an input of any arrow key of the input apparatus, and the presenting unit determines a position of the cursor in the text set image according to a physical position of the input and highlights a portion of the text set in a corresponding position of the text set image on the text input interface.

12. The apparatus according to claim 11, wherein:
when arrow keys of the input apparatus comprise an up arrow key, the detecting unit detects an input of the up arrow key, and the presenting unit determines, according to a physical position of the input, that the cursor moves to right above the text set image and highlights the portion of the text set right above the text set image;
when the arrow keys of the input apparatus comprise a down arrow key, the detecting unit detects an input of the down arrow key, and the presenting unit determines, according to a physical position of the input, that the cursor moves to right below the text set image and highlights the portion of the text set right below the text set image;
when the arrow keys of the input apparatus comprise a left arrow key, the detecting unit detects an input of the left arrow key, and the presenting unit determines, according to a physical position of the input, that the cursor moves to the left of the text set image and highlights the portion of the text set on the left of the text set image; or
when the arrow keys of the input apparatus comprise a right arrow key, the detecting unit detects an input of the right arrow key, and the presenting unit determines, according to a physical position of the input, that the cursor moves to the right of the text set image and highlights the portion of the text set on the right of the text set image.

13. The apparatus according to claim 11, wherein:
when the detecting unit detects another input of the same arrow key within a time threshold, the presenting unit presents that the cursor moves along the circle from the current position to a next text sequentially arranged in the text set image.

14. The apparatus according to claim 10, wherein:
when arrow keys of the input apparatus comprise an omni-directional key, the detecting unit detects a rotating track of the omni-directional key of the input apparatus, and the presenting unit determines a moving direction of the cursor according to the rotating track, presents accordingly that the cursor moves along the circle in the text set image on the text input interface, and highlights a text in the position where the cursor is located.

15. The apparatus according to claim 14, wherein:
when the detecting unit detects another rotating track of the omni-directional key within a time threshold, the presenting unit determines a moving direction of the cursor according to the rotating track; and
when the moving direction of the cursor is the same as the arranging sequence of texts in the text set image, the presenting unit presents that the cursor moves along the circle from the current position to a next text sequentially arranged in the text set image; or
when the moving direction of the cursor is reverse to the arranging sequence of texts in the text set image, the presenting unit presents that the cursor moves along the circle from the current position to a previous text sequentially arranged in the text set image.

16. The apparatus according to claim 11, further comprising an obtaining unit, wherein:
when the detecting unit detects no input of the same arrow key within a time threshold, or when the detecting unit detects no input of the same arrow key within the time threshold and another input of the same arrow key is detected after the time threshold expires, or when the detecting unit detects an input of an enter key in the input apparatus, the obtaining unit queries the text database to obtain an input set that matches the text currently selected by the cursor in the text set image; and
the presenting unit presents the input set obtained by the obtaining unit on the text input interface for inputting of the input apparatus.

17. The apparatus according to claim 16, wherein the input apparatus of the apparatus is a shuttle remote that comprises an omni-directional key used to move clockwise or counter-clockwise along the circle and allow an input in any position along the circle.

18. The apparatus according to claim 10, wherein:
when the text database comprises a letter database, the presenting unit presents a text set image corresponding to the letter database on the text input interface and displays a cursor in a default position of the text set image, wherein the text set image comprises letters arranged along a circle and the cursor is used to indicate a current selected letter; or
when the text database comprises a number database, the presenting unit presents a text set image corresponding to the number database on the text input interface and displays a cursor in a default position of the text set image, wherein the text set image comprises numbers arranged along a circle and the cursor is used to indicate a current selected number; or
when the text database comprises a character database, the presenting unit presents a text set image corresponding to the character database on the text input interface and displays a cursor in a default position of the text set image, wherein the text set image comprises characters arranged along a circle and the cursor is used to indicate a current selected character.

19. The method according to claim 5, wherein presenting the input set that matches the text selected in the text set image on the text input interface for inputting of the input apparatus, comprises:
when no input of the same arrow key is detected within a time threshold, or when no input of the same arrow key is detected within the time threshold and another input of the same arrow key is detected after the time threshold expires, or when an input of an enter key in the input apparatus is detected, querying the text database to obtain an input set that matches the text currently selected by the cursor in the text set image; and
presenting the input set on the text input interface for inputting of the input apparatus.

20. The apparatus according to claim 14, further comprising an obtaining unit, wherein:
when the detecting unit detects no input of the same arrow key within a time threshold, or when the detecting unit detects no input of the same arrow key within the time threshold and another input of the same arrow key is detected after the time threshold expires, or when the detecting unit detects an input of an enter key in the input apparatus, the obtaining unit queries the text database to obtain an input set that matches the text currently selected by the cursor in the text set image; and
the presenting unit presents the input set obtained by the obtaining unit on the text input interface for inputting of the input apparatus.
